(19) United States
(12) Patent Application Publication
(10) Pub. No.: US 2004/0121763 A1
(43) Pub. Date: Jun. 24, 2004

(54) Method for providing television coverage, associated television camera station, receiving station and system

(76) Inventors: Guido Franceschini, Torino (IT); Mauro Qauglia, Torino (IT); Andrea Varesio, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/473,617

(22) PCT Filed: Mar. 26, 2002
(86) PCT No.: PCT/IT02/00194

(30) Foreign Application Priority Data
Mar. 30, 2001 (IT) TO20001A000309

(51) Int. Cl. H04N 7/14

(52) U.S. Cl. 455/414.1; 348/14.01

(57) ABSTRACT

At least one camera station (1, 2), which is usually mobile, is provided in order to generate television picture signals. These picture signals are coded in coded digital form so as to produce a coded digital signal at output (62) whose bit rate can be selectively varied. The camera station (1) is associated with at least one mobile telephony channel (41, 42, . . . , 4n) which can be selectively activated in order to provide a transmission capacity which is available at that moment. The coded signal is transmitted, selectively adapting its bit rate to the transmission capacity available at that moment. The number of mobile telephony channels (41, 42, . . . , 4n) that can be activated can also be selectively increased in order to increase available transmission capacity.

### TECHNICAL FIELD

The present invention relates to television techniques and was developed with particular attention to potential application in providing television coverage using mobile stations.

### BACKGROUND ART

In cases where shooting is carried out with a view to live transmission, the solution which is currently favored in applications including, for example, shooting sports events such as bicycle races or other types of outdoor coverage requires that a mobile station be available which is connected by means of a short-distance link (a radio link, for example) to a base station situated in the vicinity. This base station may consist for example of a vehicle equipped to ensure that the signals received from the mobile station can be sent (e.g., via a satellite link) to a production facility where they are subsequently broadcast. In certain cases (e.g., for some types of sports event), it is also necessary to have a vehicle (usually a helicopter) which can follow the movements of the mobile station.

The number—and the quality—of the instruments which must be deployed in the field is thus so considerable as to limit the use of these techniques to applications and events whose scope or importance is such as to justify the costs involved.

For this reason, live mobile televising is used in a relatively restricted range of applications, and in many cases (e.g., for television interviews, news, etc.) it is still preferable to use recorded footage, which means that the recording medium must be sent to a broadcasting center before the footage can be aired.

In view of this situation, live mobile televising is still virtually unknown in such applications as remote surveillance, police operations, remote assistance for repair and maintenance personnel, etc., though these are all applications where real-time television coverage could prove extremely useful.

### DISCLOSURE OF THE INVENTION

The object of the present invention is thus to provide a solution capable of satisfying all of the needs indicated above.

In accordance with the present invention, this object is achieved by means of a method having the characteristics detailed in the following claims. The invention also relates to the associated camera station, the associated receiving (or “studio” station) and to the entire system consisting of the receiving station and at least one camera station that can be connected to it.

In order to permit television shooting to be carried out under mobile conditions, the solution in accordance with the invention benefits from the extensive geographical coverage that mobile telephony networks have achieved in recent years.

The solution in accordance with the invention, in fact, makes it possible for a mobile television camera station—consisting, in the currently preferred embodiment of the invention, of a set of devices capable of being carried and used by a single operator—to connect directly with a mobile telephony network so that the television signal can be sent to a receiving station which acts as a studio station.

All of this is accomplished using an ordinary public mobile telephony network and ensuring an image quality which is acceptable for the applications outlined above.

In addition, the bit rate of the coded television signal generated in the camera station and the resources (typically, the number of mobile telephony channels) used to transmit this signal to the receiving station can be mutually adapted.

This is achieved by using a general dynamic adaptation criterion, which if necessary is capable of allowing for reductions in the number of channels available for transmission which may occur if one or more of these connections is interrupted. The receiving station can selectively increase the number of transmission channels available to the camera station when the characteristics of the television signal are such that the available transmission bandwidth must be increased.

### BRIEF DESCRIPTION OF DRAWINGS

The following description of the invention, which is intended purely by way of example and is not to be construed as limiting, will make reference to the accompanying drawings, where:

FIG. 1 is a block diagram illustrating the general architecture of a television camera station capable of being used in a system in accordance with the invention, and

FIG. 2 is a block diagram illustrating the structure of the associated receiving or studio station.

### BEST MODE FOR CARRYING OUT THE INVENTION

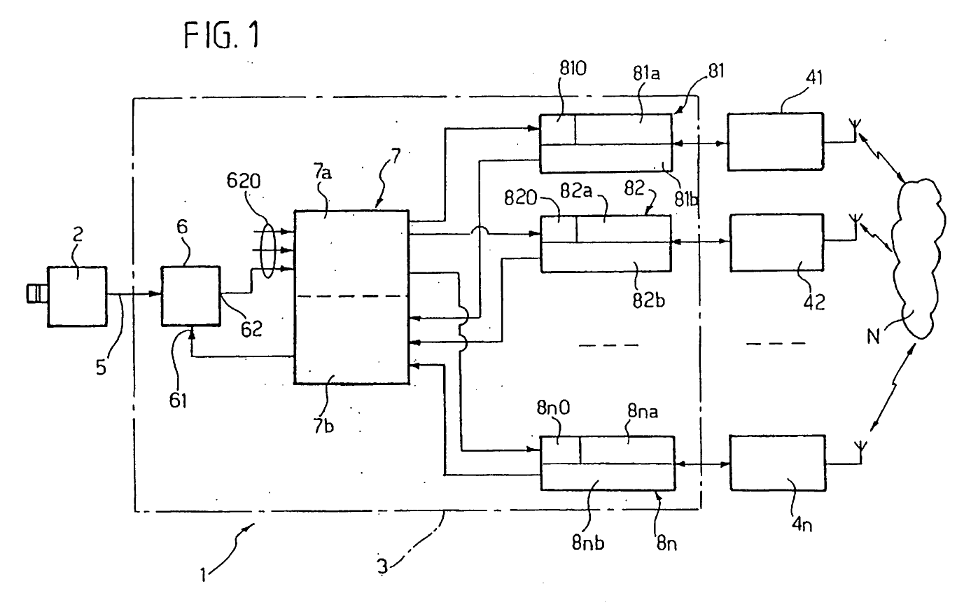

In the block diagram shown in FIG. 1, reference 1 designates a mobile television camera station as a whole.

In the currently preferred embodiment of the invention, the station 1 is capable of being configured as a set of devices designed to be carried and actuated by a single operator. The later may be, for example, a reporter traveling in a particular geographical area in order to cover a sports event, news story, natural occurrence or so forth.

In its most general configuration, the station 1 consists essentially of the following:

A television camera 2 which may consist, for example, of a normal video camera or camcorder as currently produced,

A processing unit 3 such as a personal computer, and

A plurality of terminals for mobile telephony, consisting—in the simplest embodiment of the invention—of a certain number of mobile terminals 41, 42, . . . , 4n of an ordinary public mobile telephony network such as a GSM telephony network, for example.

The video camera 2 may be a camcorder as currently produced but configured in such a way as to generate at its output, designated as 5, both a normal PAL (or SECAM or NTSC) television signal and a corresponding television signal which has already been converted into compressed digital form, e.g., in accordance with the 25 Mbit/s SONY DV standard (IEEE 1394) or any Webcam format.

The processing unit 3 may consist of a “wearable” personal computer which can be carried by an operator together with the terminals 41, 42, . . . , 4n and the video camera 2. “Wearable” personal computers of this kind are available, for example, from the manufacturer “XYBERNAUT”.

Specifically, the processing capacity of the unit 3 is selected in such a way as to make it possible to implement the following processing modules:

A coder 6 operating, for example, in accordance with the MPEG standard and preferably in accordance with the MPEG4 standard,

A mux/demux unit 7 comprising a multiplexer section 7a and a demultiplexer 7b, and

A certain number of interfaces (which are typically serial interfaces organized in accordance with the RS232 standard), designated by the references 81, 82, . . . , 8n and capable of permitting bi-directional communication between the mux/demux unit 7 and the various mobile telephone terminals 41, 42, . . . , 4n.

Each of the interfaces 81, 82, . . . , 8n usually features a first transmitting portion or section identified by the suffix “a”, which accomplishes transmission from the mux/demux unit 7 to a corresponding terminal 41, 42, . . . , 4n and a second receiving portion or section, identified by the suffix “b”, which permits communication in the opposite direction.

The reference N designates the telephony network in general, which comprises the mobile terminals 41, 42, . . . , 4n.

The coder 6 (the following description will refer by way of example to an MPEG4 coder, as this is the solution which is currently preferred) is configured, in accordance with criteria which are familiar from the prior art and thus need not be described here, in such a way that it can automatically adapt its output bit rate to the transmission bandwidth available through interfaces 81, 82, . . . , 8n: the associated information is carried towards the coder 6 by the multiplexer 7a.

Additionally, the coder 6 features a control input 61 which, in relation to a corresponding signal received from the demultiplexer section 7b of unit 7, makes it possible to selectively vary at least one parameter selected between coded signal resolution and frame rate.

This capacity for variation can be utilized for at least two different purposes.

The first of these purposes is that of being able to modify the operating parameters of the coder 6 in such away that the aforesaid parameters can be varied for any given bit rate present on the output line 62 from coder 6.

The second purpose is that of ensuring that a compressed and coded digital signal corresponding to a bit stream of selectively determined value (e.g., 9.6 Kbit, 19.2 Kbit or, in general, n×9.6 Kbit) is present on the output line 62 from coder 6. The reason for selecting a value equal to 9.6 Kbit/s as a resolution or modularity element is clearly connected to the transmission capacity of the individual terminals 41, 42, . . . , 4n which—in accordance with the current GSM standard—is in fact equal to 9.6 Kbit/s.

The general structure and operating criteria of a MPEG coder such as that designated as 6 in FIG. 1 provided in the accompanying drawings can be regarded as entirely familiar to persons skilled in the prior art, and thus need not be described in detail here.

In particular, it is known that the bit stream produced at the output of such an encoder not only includes visual information, but also comprises associated audio data as well as any data type information which may be provided.

Specifically, the coder 6 (and the decoder 12 which will be describe below, and for which the same considerations apply symmetrically) in reality comprises a section functioning as a video coder and a section functioning as an audio coder. This fact—which reflects technical needs which will be familiar to a person skilled in the art—is illustrated schematically only in FIG. 1, where the reference 620 designates a complex of lines located at the output of the coder 6 and used to carry the set of signals corresponding and/or linked to the picture signal.

In the remainder of this description (and in the appended claims), it will thus be assumed that the wording “coded digital signal” can refer to the complex made up of the signal representing the visual information per se and of the corresponding audio signal (coded, for example, on the basis of the MPEG4 standard, if necessary taking the bit rates involved into account), as well as of any associated data signals.

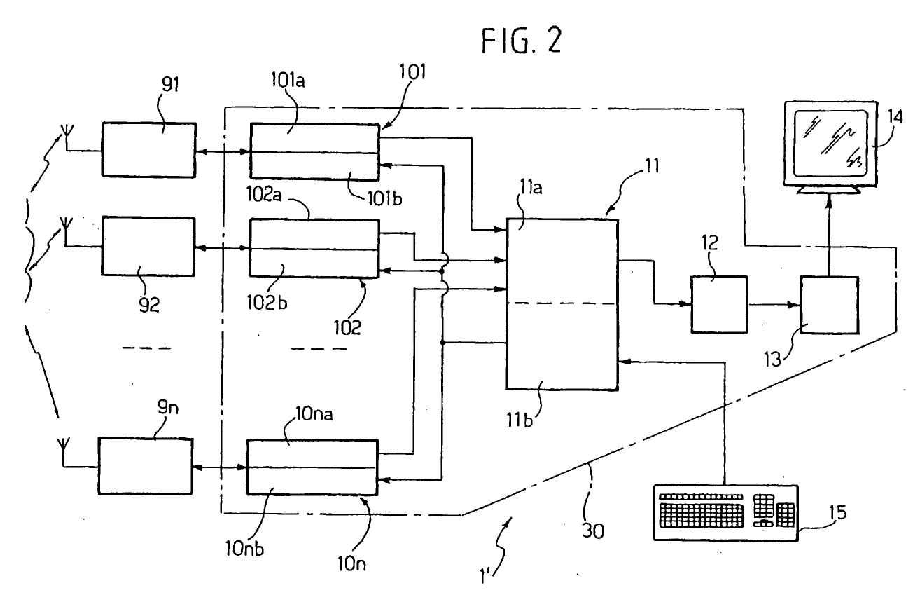

Turning now to a description (with reference to FIG. 2) of the characteristics of the receiving (or studio) station designated as 1′, it should be noted that the structure of this station substantially mirrors that of the camera station illustrated in FIG. 1.

The references 91, 92, . . . , 9n, in fact, designate a corresponding number of telephony terminals (not necessarily mobile) that are capable of connecting to terminals 41, 42, . . . , 4n at the camera station through the network designated as a whole by the letter N. Downstream of terminals 91, 92, . . . , 9n, the station is provided with a set of interfaces (here again, these are serial interfaces, and specifically interfaces in accordance with the RS232 standard) designated by the numbers 101, 102, . . . , 10n. In turn, each of the interfaces in question comprises a receiving section identified by the suffix “a”, and a transmitting section identified by the suffix “b”.

Proceeding in the direction of propagation for the received signal, a further mux/demux unit 11 situated downstream of interfaces 101, 102, . . . , 10n comprises a demultiplexer section 11a and a multiplexer section 11b.

Reference 12 designates an MPEG (e.g., MPEG4) decoder used for the output signal provided by the demultiplexer 11a. Reference 13 designates a so-called synchronizer which acts—as will be described in greater detail below—on the signal decoded in decoder 12, while reference 14 designates a monitor used to view the received television signal.

Reference 15, on the other hand, designates a control device available at the receiving or studio station 11.

In one possible embodiment of the invention, the device 15 consists simply of the keyboard of a personal computer 30 used to implement the complex of elements 101, 102, . . . ,10n; 11 and 12 illustrated above, and whose monitor corresponds to the monitor 14.

By means of the device 15, it is thus possible to send corresponding control signals via the multiplexer 11b to the camera station or stations 1 associated with station 1′. A single receiving station 1′, in fact, can be associated with several camera stations 1, which enables station 1′ to perform the functions of a television studio for the camera stations.

To maximize system flexibility, it would also be possible to equip a single operator with several systems 1 of the type illustrated in FIG. 1. For example, this can be done in order to enable an operator to change from a first system or station which is unusable at the moment (e.g., because its batteries are insufficiently charged) to another system or station 1 which is entirely identical, fully charged and able to operate correctly.

In a typical application configuration of the system in accordance with the invention, the station 1′ calls the mobile station or stations 1 from which live television signals are to be received at the desired time. This can be accomplished by means of a normal call operation (controlled by the unit 15 following an appropriate command imparted by an operator) which sets up a connection via the network N between the camera station 1 (or each camera station 1) and the receiving station 1′. This connection involves a (maximum) number of channels selectively determined in relation to the characteristics of the television footage to be shot.

For example, the unit 15 can (at least initially) configure the system in such a way as to use only one of the communication channels available via the network N: this may for instance be a single GSM connection channel established through terminals 41 and 91.

If television coverage is to be provided for a rapidly changing phenomena (such as people or objects in movement, for example), the device 15 makes it possible to control the system so that that the number of communication channels to be used is determined in such a way as to ensure a correspondingly high transmission capacity (e.g., by activating four, five or more GSM communication channels).

Naturally, though the example illustrated here refers to a transaction (system activation) which is initiated from the fixed or studio station 1′, nothing prevents the process from being activated on demand by the camera station 1, for example by informing the fixed station 1′ that certain images can be transmitted to it. This can be accomplished by using, for example, the data channel included in one of the lines 620 shown in FIG. 1, and proceeding in such a way that the camera station 1 calls the fixed station 1′ on one of the available GSM channels and asks that the fixed station start the process as described above of calling and selecting the number of mobile radio channels to be used.

As indicated earlier, the device 15 makes it possible to establish the maximum number of communication channels which will be used to communicate between the camera station 1 and the studio station 1′. The fact that a number—and a maximum number—is employed for this purpose is intended to allow for the likelihood that, as a result of the decision to use a certain number of channels for transmission (a decision made in relation to the characteristics of the television signal to be transmitted), one or more of the channels which are virtually set aside for activation may be, at least momentarily, interrupted or unavailable.

The solution in accordance with the invention is in any case capable of accommodating such an event without allowing it to interrupt system operation.

It should also be noted that the fact that the station 1′ is referred to on several occasions above as the “fixed” station is intended essentially to emphasize that this station is not directly constrained by the need for mobility in a given geographical area in order to shoot television footage. In reality, the station 1′ can also be configured as a mobile station which can maintain a connection with the camera station or stations 1 as it moves through the coverage area provided by network N.

Suppose, for example, that an operator (the “director”) finds it necessary to establish a connection with a mobile station (which will be assumed below to be station 1) in order to produce a television signal whose resolution, frame rate, etc., are such as to require that a set of k channels (k=1 . . . , n) be available, and which thus calls for a certain transmission capacity (equal to k×9.6 kbit/s in the implementation example illustrated here).

Through a corresponding command imparted through the device 15, for example, the system is configured in such a way as to set up—in accordance with the prior art—k communication channels (in practice by making k calls) to the mobile unit 1.

At this point (and again by means of the device 15), the director can also send a further command signal to the coder 6 in order to adjust the characteristics (frame rate, resolution, etc.) of the television signal which will be transmitted by the unit 1.

Through the multiplexer section 11b of element 11, the corresponding command issued by the device 15 is sent (preferably in parallel on all interfaces 101, 102, . . . , 10n to provide the redundancy needed to ensure that the corresponding command signal will be received) to the terminals 91, 92, . . . , 9n.

The command signal transmitted via the network N is received by the terminals 41, 42, . . . , 4n and, by means of the interfaces 81 through 8n (and more specifically, through the receiver sections identified by the suffix “b”) and the demultiplexer 7b, reaches the adjustment input 61 on coder 6.

In all cases, the bit rate of the signal on the output line 62 is regulated in such a way as to correspond to the bandwidth available for transmission. For example, if a command to use k channels has been made through the device 15, the coder 6 will be configured (in accordance with the prior art) so that the signal present on the output line 62 will have a bit rate which is k times the transmission capacity of the single channel available on the mobile network N.

The coded (e.g., MPEG4) bit stream which has thus been made available will be sent to the multiplexer 7a which distributes it to the various interfaces 81, 82, 8n so that it can be transmitted on the network N.

The criterion for dividing and forwarding the coded bit stream to the various interfaces 81, 82, . . . , 8n corresponds to a determined law.

The bit stream on the output line 62 (or rather, on the complex of lines 620, as any audio and data components which may be present are also to be taken into account) is divided into packets (packetized) in multiplexer 7a, preferably in such as way as group the signals corresponding to one frame or fraction of a frame in each individual packet. All of this, obviously, is designed to prevent information which in reality relates to the same picture or portion of a picture from being divided between different packets which will follow different virtual paths through the network N.

The packets thus created (which may for example correspond to 20-40 milliseconds of television signal and the associated audio signals) are distributed by the multiplexer 7a to the various interfaces 81, 82, . . . , 8n. This preferably takes place as a function of the fill level of the corresponding input buffers 810, 820, . . . , 8n0 provided at the transmitting sections 81a, 82a, . . . , 8na of the corresponding interfaces 81, 81, 8n.

In general, then, the individual packet is sent on a case by case basis to the interface 81, 82, . . . , 8n whose corresponding buffer 810, 820, . . . , 8n0 is the least full at that moment, and thus has the lowest fill level.

The packets thus distributed among the various channels are transmitted to the network N by the corresponding transmitting modules or terminals 41, 42, 4n at station 1 so that they can then be received by the corresponding receiving modules or terminals 91, 92, . . . , 9n at station 1′.

This is accomplished, for example, by means of a transmission-side packet renumbering technique which makes it possible to reorder the packets and thus reconstruct the transmission sequence on the reception side.

Transmission usually entails an initial stage in which the various terminals 41, 42, . . . , 4n (and the corresponding terminals 91, 92, . . . , 9n) assume a so-called “command mode” prior to passing to the configuration or mode currently known as “data mode”, which is used for signal transmission.

As indicated above, the command transmitted from the device 15 corresponds to the maximum number k of connections which will be used to transmit the television picture.

If, after communication has been established on k channels, one or more of these connections is abruptly interrupted, the associated information will be collected by the system in accordance with the prior art. The system can then activate (automatically, in most cases) a mechanism for restoring the interrupted connection, for example by making a new call to the mobile station 1.

In the meantime, the coder 6 adapts to the reduction in bandwidth caused by the interruption in the connection, proceeding in such a way that the compressed and coded signal present at output 62 is invariably and in all cases a signal whose bit rate is such that it can be absorbed and transmitted by the set of channels (which may virtually comprise a single channel) available at the time.

Regardless of the number of channels in the set used for transmission, the corresponding packets that have crossed the network N converge towards the terminals 91, 92, . . . , 9n (which here are seen essentially as receivers) which transfer them to the interfaces 101, 102, . . . ,10n. From the latter, the packets proceed towards the demultiplexer section 11a of element 11 so that the starting bit stream can be reconstructed.

The latter is then sent to a decoder 12 (whose function complements that of coder 6, and can thus be a normal MPEG4 decoder), which generates a decoded digital television signal in accordance with the prior art.

In the currently preferred embodiment of the invention, the decoder 12 performs a correction function which is intended to prevent any portions of television pictures that have been received incorrectly from leading to interference which is repeated in subsequent television pictures as a result of the prediction mechanism inherent to MPEG standard coding and decoding. In particular, the decoder 12 identifies the frame portions which were not received correctly (e.g., because of excessive noise interference) and overrides their content so that it corresponds to the content of “homologous” signals, such as the signal corresponding to the same portion of the picture received in the immediately preceding frame or to adjacent portions of the picture in the same frame which were received correctly.

The decoded signal is sent to a synchronizer module 13 whose function is to take action on the decoded signal in order to correct any losses of synchronization between the video signal and the audio signal.

Specifically, the function of the synchronizer module 13 is to correlate the video and audio signals after propagation on the network N in such a way that these signals are presented in conditions of sufficient synchronization.

The signal thus produced (including the associated audio signal) can then be viewed on a monitor 14.

An operator (the “director) who views the picture reproduced on the monitor 14 can thus decide to use the control device 15 to increase the number of communication channels used for transmission, and thus achieve a corresponding increase in the quality of the television picture which is received.

This is done in order to modify the quality of the picture reproduced on the monitor 14 according to current needs, for example as regards the frame rate (thus preventing stiff and/or jerky movement in the video picture) or as regards resolution.

As is known, in fact, the quality of a television picture will usually improve as frame rate (i.e., the number of frames transmitted per second) and the picture signal resolution presented on the monitor 14 are increased.

The same approach can be used, for example, in a remote surveillance application. An operator manning station 1′ can periodically check the picture presented on the monitor 14 in order to decide (e.g., if an individual in movement is detected) whether to increase the bandwidth which the system uses for transmission so that the individual's movements can be followed more clearly.

The operator can subsequently decide to reduce the number of channels used for transmission once it has been determined that the pictures involved are still or slowly moving images and/or images with a low intrinsic resolution.

The function of selecting the number of channels used for transmission can if necessary be delegated to the camera station 1 and/or performed automatically, e.g., as a function of movement/resolution parameters present in the coder 6 or in the decoder 12.

It will thus be readily apparent that, without detriment to the invention's underlying principles, details of construction and forms of implementation may vary widely with respect to the descriptions and illustrations provided herein, without for that reason failing to fall within the scope of the present invention.

1. A method for providing television coverage, characterized in that it comprises the steps of:
Providing one or more camera stations (1, 2) for generating television picture signals,
Coding (6) said television picture signals in digital form so as to produce a coded digital signal (62) with selectively variable bit rate,
Associating said camera station (1) with one or more mobile telephony channels (41, 42, . . . , 4n) which can be selectively activated (15) in order to provide a transmission capacity available at that moment, and
Transmitting (7; 81, 82, . . . , 8n) said coded digital signal (62) on said one or more mobile telephony channels (41, 42, ., 4n), adapting said bit rate to said transmission capacity available at that moment.

2. A method in accordance with claim 1, characterized in that said television picture signals are generated in the form of low bit rate television picture signals such as those complying with an IEEE 1394 or Web cam standard.

3. A method in accordance with claim 1 or claim 2, characterized in that said step of coding said television picture signals in coded digital form is performed in such a way that at least one parameter selected between coded signal resolution and frame rate can be varied selectively (61).

4. A method in accordance with any of claims 1 through 3, characterized in that said step of coding said television picture signals in coded digital form is performed in accordance with an MPEG standard, such as the MPEG4 standard.

5. A method in accordance with any of the foregoing claims, characterized in that it comprises the step of associating said one or more mobile telephony channels (41, 42, . . . , 4n) with mobile communication interfaces (81, 82, 8n), as well as the step of subjecting said coded digital signal to packetization, distributing the packets thus obtained among said communication interfaces (81, 82, . . . , 8n) in accordance with a determined distribution law.

6. A method in accordance with claim 5, characterized in that it comprises the step of providing said communication interfaces (81, 82, . . . , 8n) with corresponding input buffers (810, 820, . . . , 8n0), and in that said determined distribution law involves assigning the current packet to the communication interface (81, 82, . . . , 8n) whose buffer (810, 820, . . . , 8n0) is at a lowest fill level.

7. A method in accordance with any of the foregoing claims, characterized in that it comprises the step of associating said camera station (1) with one or more GSM mobile telephony channels (41, 42, . . . , 4n).

8. A method in accordance with any of the foregoing claims, characterized in that it comprises the step of supplying (15) said one or more camera stations with a command signal indicating a maximum number of mobile telephony channels (41, 42, . . . , 4n) which can be activated to provide said transmission capacity.

9. A television camera station, characterized in that it comprises:
A camera (2) for generating television picture signals,
A coder (6) for coding said picture signals in coded digital form so as to produce a coded digital signal at output (62) whose bit rate can be selectively varied,
One or more mobile telephony channels (41, 42, . . . , 4n) which can be selectively activated in order to provide a transmission capacity available at that moment, and
A transmitter (7; 81, 82, . . . , 8n) for transmitting said coded digital signal (62) on said one or more mobile telephony channels (41, 42, . . . , 4n), selectively adapting said bit rate to said transmission capacity (41, 42, . . . , 4n) available at that moment.

10. A camera station in accordance with claim 9, characterized in that said camera (2) generates said television picture signals in the form of low bit rate television picture signals such as those complying with an IEEE 1394 or Webcam standard.

11. A camera station in accordance with claim 9 or claim 10, characterized in that said coder (6) is configured to selectively vary (61) at least one parameter selected between the resolution and the frame rate of said television picture signals.

12. A camera station in accordance with any of claims 9 through 11, characterized in that said coder (6) operates in accordance with an MPEG standard, such as the MPEG4 standard.

13. A camera station in accordance with any of the foregoing claims 9 through 12, characterized in that said transmitter (7; 81, 82, . . . , 8n) comprises communication interfaces (81, 82, . . . , 8n) associated with said one or more mobile telephony channels (41, 42, . . . , 4n) and in that said transmitter subjects coded digital signals to packetization, distributing the packets thus obtained among said communication interfaces (81, 82, . . . , 8n) in accordance with a determined distribution law.

14. A camera station in accordance with claim 13, characterized in that said communication interfaces (81, 82, . . . , 8n) are provided with corresponding input buffers (810, 820, . . . , 8n0) and said transmitter (7) assigns the current packet to the communication interface (81, 82, . . . , 8n) whose buffer (810, 820, . . . , 8n0) is at a lowest fill level.

15. A camera station in accordance with any of the foregoing claims 9 through 14, characterized in that said one or more mobile telephony channels (41, 42, . . . , 4n) is a GSM channel.

16. A camera station in accordance with any of the foregoing claims 9 through 15, characterized in that it is configured as a mobile station, which can preferably be carried and actuated by a single operator.

17. A receiving station for television footage, characterized in that it comprises:
One or more telephony channels (91, 92, . . . , 9n) which can be selectively activated in order to provide a reception capacity available at that moment, and
A decoder (12) capable of receiving picture signals in coded digital form from said one or more telephony channels (91, 92, . . . , 9n) with a bit rate that can be selectively varied in relation to the reception capacity available at that moment on said one or more telephony channels (91, 92, 9n).

18. A receiving station in accordance with claim 17, characterized in that said decoder (12) is configured to selectively vary at least one parameter selected between the resolution and the frame rate of said television picture signals.

19. A receiving station in accordance with claim 17 or claim 18, characterized in that said decoder (12) operates in accordance with an MPEG standard, such as the MPEG4 standard.

20. A receiving station in accordance with any of the foregoing claims 17 through 19, characterized in that said decoder (12) is configured to identify portions of said television picture signals that are affected by interference upon reception, replacing them for decoding purposes with homologous portions of picture signals which were received correctly.

21. A receiving station in accordance with any of the foregoing claims 17 through 20, characterized in that it comprises a synchronizer module (12) which performs a re-synchronization function for the video components and the audio components of the signal decoded by said decoder (12).

22. A receiving station in accordance with any of the foregoing claims 17 through 21, characterized in that said one or more telephony channels (91, 92, . . . , 9n) is a GSM channel.

23. A receiving station in accordance with any of the foregoing claims 17 through 22, characterized in that it comprises a control device (15) for generating a signal indicating the maximum number of telephony channels (41, 42, . . . , 4n; 91, 92, . . . , 9n) that can be activated to provide said transmission capacity which is available at that moment.

24. A system for providing television coverage comprising:
One or more camera stations (1), and specifically one or more camera stations in accordance with any of claims 9 through 16,
A receiving stations, and specifically a receiving station in accordance with any of claims 17 through 23; said one or more camera stations (1) and said receiving station (1′) having the capability of being mutually connected in order to respectively transmit and receive a coded television picture signal over at least one mobile telephony channel (41, 42, . . . , 4n; 91, 92, . . . , 9n).
